(19) United States
(12) Patent Application Publication
(10) Pub. No.: US 2026/0237571 A1
(43) Pub. Date: Aug. 13, 2026

(54) AUTOMATIC TRANSFER SWITCH

(71) Applicant: KUTAI ELECTRONICS INDUSTRY CO., LTD., KAOHSIUNG CITY (TW)

(72) Inventor: WEN-FENG LU, KAOHSIUNG CITY (TW)

(21) Appl. No.: 19/049,267

(22) Filed: Feb. 10, 2025

(51) Int. Cl. H01H 3/26; H01H 3/38; H01H 9/02; H02J 9/06

(52) U.S. Cl. CPC H01H 3/26; H01H 3/38; H01H 9/02; H02J 9/068

(57) ABSTRACT

An automatic transfer switch is provided. The automatic transfer switch includes a power management unit, a driving unit, and a power source switch unit. When the power management unit detects that power provided by a normal power source is interrupted, the power management unit drives a motor of the driving unit to drive a first rotary disc, a secondary rotary disc, and a cam on a crankshaft of the power source switch unit to rotate in turn for switching connection between load equipment and the normal power source or a backup power source. The switch is provided with a neutral position during the switching between the normal and the backup power sources for preventing damages of the load equipment caused by possible power cross or accidental short circuit occurring during the switching of the power sources. Thereby a service life of the load equipment is increased effectively.

### BACKGROUND OF THE INVENTION

### Field of the Invention

The present invention relates to a transfer switch used in an electricity distribution system, especially to an automatic transfer switch.

### Description of the Related Art

One of the most important concerns in modern life is the continuous supply of power. Especially in medical industry and manufacturing industry, safety and continuity of the power supply are extremely crucial because no power interruption is allowed.

An automatic transfer switch available now mainly includes a motor, a lever connected to the motor, a circuit breaker (CB) connected to a normal power source, and a circuit breaker (CB) connected to a backup power source. The motor can rotate clockwise or counterclockwise. Thereby users can select electrical connection to the normal power source or the backup power source by pushing the lever to the CB of the normal power source or the CB of the backup power source. Thereby the power source is switched. However, during the switching between the normal power source and the backup power source, the automatic transfer switch available now is not provided with a neutral position in which the switch is not connected to any power source. Thus certain problems including power cross or accidental short circuit may occur during the switching of the power source. These problems further lead to damages of load equipment, and even cause more serious shortcomings such as explosion.

Thus there is room for improvement and there is a need to provide a novel an automatic transfer switch which overcomes the above shortcomings.

### SUMMARY OF THE INVENTION

Therefore, it is a primary object of the present invention to provide an automatic transfer switch which is provided with a neutral position during a switching process between a normal power source or a backup power source for improving safety in power transfer operations.

In order to achieve the above object, an automatic transfer switch according to the present invention includes a switch body, a power management unit, a driving unit, and a power source switch unit.

The switch body consists of a first mounting space and a second mounting space adjacent to each other and formed inside the switch body. A plurality of partitions is used for separating the second mounting space into a plurality of rooms.

The power management unit is disposed on the switch body and provided with a control module, a transfer module having a transfer switch and a linkage rod assembled with the transfer switch, and a power supply module connected to the transfer switch of the transfer module for sending signals.

The driving unit is mounted in the first mounting space of the switch body and provided with a motor, a first cover, a transmission shaft, a first rotary disc, an elastic member, a second rotary disc, and a second cover. The transmission shaft, the first rotary disc, the elastic member, and the second rotary disc are mounted in a space formed between the first cover and the second cover aligned and joined together. The motor is not only connected to the control module of the power management unit for sending signals but also electrically connected to the power supply module of the power management unit. The first cover is provided with a first through hole through which a rotary shaft of the motor is inserted to be connected to the transmission shaft having a plurality of first ratchets arranged therearound. The first rotary disc consists of a first axial hole at a center thereof, a first end surface, and a second end surface opposite to the first end surface. A first assembly ring and a second assembly ring are respectively formed on the first end surface and the second end surface of the first rotary disc. A plurality of second ratchets is formed on a wall surface of a hole of the first assembly ring and able to engage with the first ratchets around the transmission shaft. Two curved first flanges are disposed on a circumferential surface of the first rotary disc and arranged opposite to each other. One end of the elastic member is assembled with the second assembly ring of the first rotary disc. The second rotary disc is provided with a second axial hole at a center thereof, a first end surface, and a second end surface opposite to the first end surface. A third assembly ring and a cam portion are respectively formed on the first end surface and the second end surface of the second rotary disc. The elastic member is mounted in a hole of the third assembly ring and the other end of the elastic member is assembled with the third assembly ring. Two curved second flanges are disposed on a circumferential surface of the third assembly ring and opposite to each other. A stopping portion is formed at a rear end of the second flange. A transmission portion is arranged at a center of a surface of the cam portion. A second through hole is mounted to the second cover and the transmission portion of the second rotary disc is inserted into the second mounting space of the switch body through the second through hole of the second cover. The first cover further includes two opposite first leaf springs and two opposite second leaf spring arranged at an inner surface of the first cover and located around the first through hole. One end of the first leaf spring is provided with a first guide portion and a first stopping portion arranged adjacent to each other. One end of the second leaf spring is provided with a second guide portion and a second stopping portion disposed adjacent to each other. The first guide portion of the first leaf spring and the second guide portion of the second leaf spring are corresponding to the two first flanges of the first rotary disc. The first stopping portion of the first leaf spring and the second stopping portion of the second leaf spring are corresponding to the two second flanges of the second rotary disc. An elastic strip is disposed on the second cover and assembled with the linkage rod of the transfer module. A bottom end of the linkage rod is in contact with and abutting against a circumference of the cam portion of the secondary rotary disc.

The power source switch unit is disposed in the second mounting space of the switch body and composed of a crankshaft, a plurality of driven members, a plurality of first conductors, a plurality of second conductors, a plurality of elastic bodies, a plurality of normal power source electrodes and a plurality of backup power source electrodes. One end of the crankshaft is mounted to the transmission portion of the second rotary disc and provided with a plurality of cams spaced apart from one another in a lengthwise direction and located at the rooms of the second mounting space of the switch body correspondingly. Each of the driven members is provided with a first cavity and a second cavity and a third cavity disposed on two opposite sides of the first cavity. The cams of the crankshaft are mounted in the first cavity of the respective driven members correspondingly. A bump is formed on each of two opposite walls of the first cavity to be abutting against and contacted with the cam of the crankshaft. The first conductor and the second conductor are respectively mounted in the second cavity and the third cavity of the respective driven members. Both the second cavity and the third cavity are provided with one of the elastic bodies for being in contact with and abutting against the first conductor and the second conductor. Each of the normal power source electrodes and each of the backup power source electrodes are both arranged in each of the rooms of the second mounting space correspondingly. The normal power source electrode is moveably contacted with or separated from the first conductor. The backup power source electrode is moveably contacted with or separated from the second conductor.

Preferably, two magnetic bodies are disposed on a surface of the cam portion of the second rotary disc of the driving unit and positioned on opposite sides of the transmission portion. Two sensors are arranged at an inner surface of the second cover, positioned on opposite sides of the second through hole, and corresponding to the two magnetic bodies on the second rotary disc. The two sensors are connected to the control module of the power management unit for sending signals.

Preferably, a first mounting slot is arranged at the second assembly ring of the first rotary disc of the driving unit for mounting one end of the elastic member. A second mounting slot is formed on the third assembly ring of the second rotary disc for mounting the other end of the elastic member.

Preferably, a long slot is mounted to one side of the switch body. A notch is formed on one side of the first cover and one side of the second cover joined each other. A position and a shape of the notch is corresponding to a position and a shape of the long slot of the switch body. The automatic transfer switch further includes a lever member provided with an assembly hole and a plurality of fifth ratchets is formed on a wall surface of the assembly hole. A plurality of third ratchets is disposed on an outer surface of a cylindrical wall of the first assembly ring of the first rotary disc for being engaged with the fifth ratchets on the assembly hole of the lever member. A toggle lever is formed on one side of the lever member and protruding from the long slot of the switch body through the notch located on the first cover and the second cover.

Preferably, two third leaf springs are disposed on the inner surface of the first cover and located at an area between the first through hole and the first leaf spring and an area between the first through hole and the second leaf spring correspondingly. A plurality of a fourth ratchets is disposed beside the third ratchets on the first assembly ring of the first rotary disc and abutting against and limited by the two third leaf springs on the inner surface of the first cover.

Preferably, the control module of the power management unit is a programmable logic controller (PLC).

Preferably, the switch body is formed by two cases aligned and joined together.

While detecting that power supplied by the normal power source is interrupted or lost, the power management unit drives the motor of the driving unit to drive the first rotary disc, the secondary rotary disc, and the cam on the crankshaft of the power source switch unit to rotate in turn for switching connection between load equipment and the normal power source or a backup power source. The present power source switch unit switch is provided with a neutral position during a switching process between the normal power source and the backup power source for preventing damages of the load equipment caused by possible power cross or accidental short circuit occurred during the switching of the power sources. Thereby a service life of the load equipment is improved significantly.

### BRIEF DESCRIPTION OF THE DRAWINGS

FIG. 1 is a perspective view of an embodiment according to the present invention;

FIG. 2 is an exploded view of an embodiment according to the present invention;

FIG. 3 is a partial exploded view of an embodiment according to the present invention;

FIG. 4 is another partial exploded view of an embodiment according to the present invention;

FIG. 5 is a sectional view of an embodiment according to the present invention;

FIG. 6 is another sectional view of an embodiment according to the present invention;

FIG. 7 is a further sectional view of an embodiment according to the present invention;

FIG. 8 is a further sectional view of an embodiment according to the present invention;

FIG. 9 is a schematic drawing showing an embodiment in use according to the present invention;

FIG. 10 is another schematic drawing showing an embodiment in use according to the present invention;

FIG. 11 is a further schematic drawing showing an embodiment in use according to the present invention;

FIG. 12 is a further schematic drawing showing an embodiment in use according to the present invention; and

FIG. 13 is a schematic drawing showing switching of power sources of an embodiment according to the present invention.

### DETAILED DESCRIPTION OF THE PREFERRED EMBODIMENT

In order to learn technical content, features, and functions of the present invention more clearly and completely, please refer to the following embodiments with related figures and reference signs.

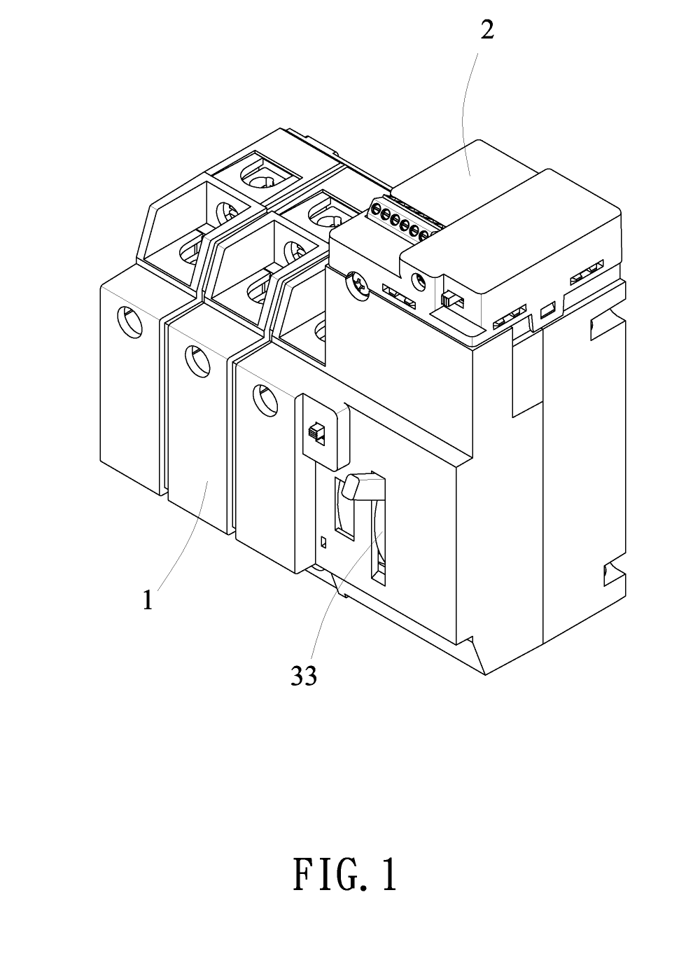

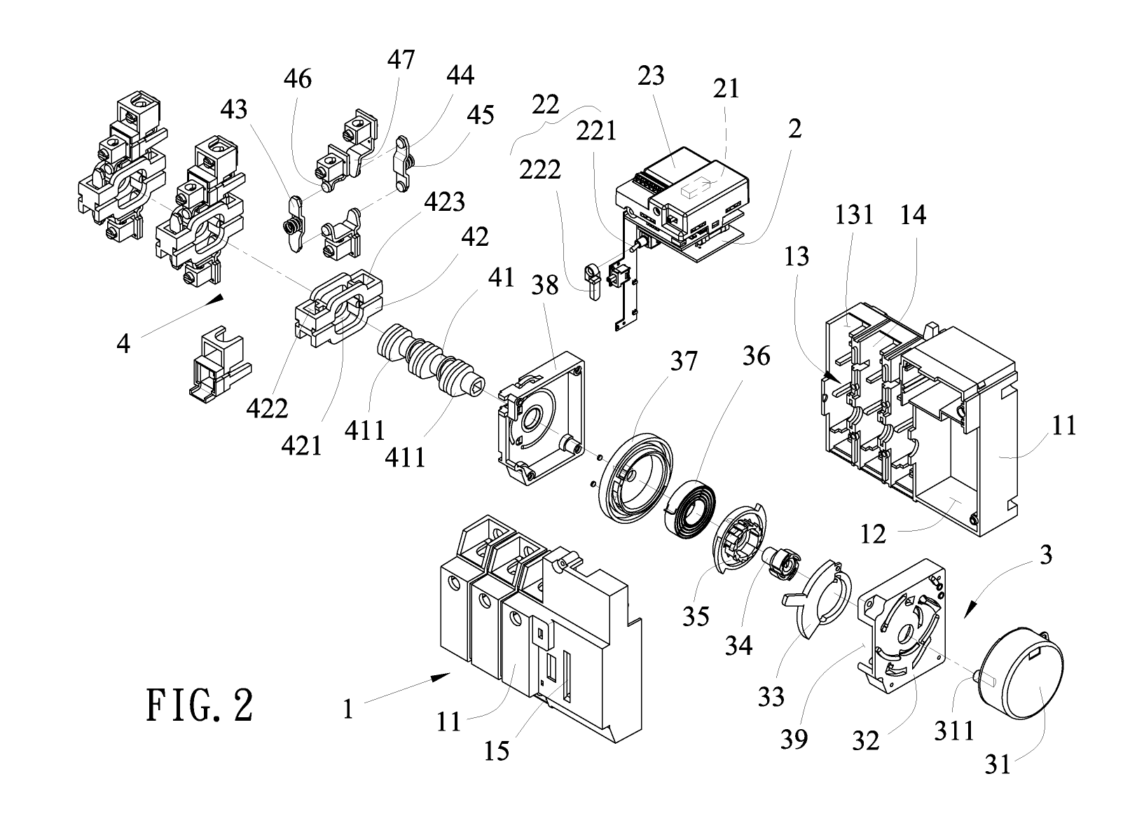

Refer to FIGS. 1 and 2, an automatic transfer switch according to the present invention includes a switch body 1, a power management unit 2, a driving unit 3, and a power source switch unit 4.

The switch body 1 consists of two cases 11 aligned and joined together, a first mounting space 12 and a second mounting space 13 arranged inside the switch body 1 and adjacent to each other, a plurality of partitions 14 for separating the second mounting space 13 into a plurality of rooms 131, and a long slot 15 mounted to one of the cases 11.

The power management unit 2 is disposed on the switch body 1 and used for detecting whether there is an interruption or loss to a normal power source. The power management unit 2 is provided with a control module 21 therein, a transfer module 22 having a transfer switch 221 and a linkage rod 222 arranged at the transfer switch 221, and a power supply module 23 connected to the transfer switch 221 of the transfer module 22 for sending signals. The control module 21 is a programmable logic controller (PLC).

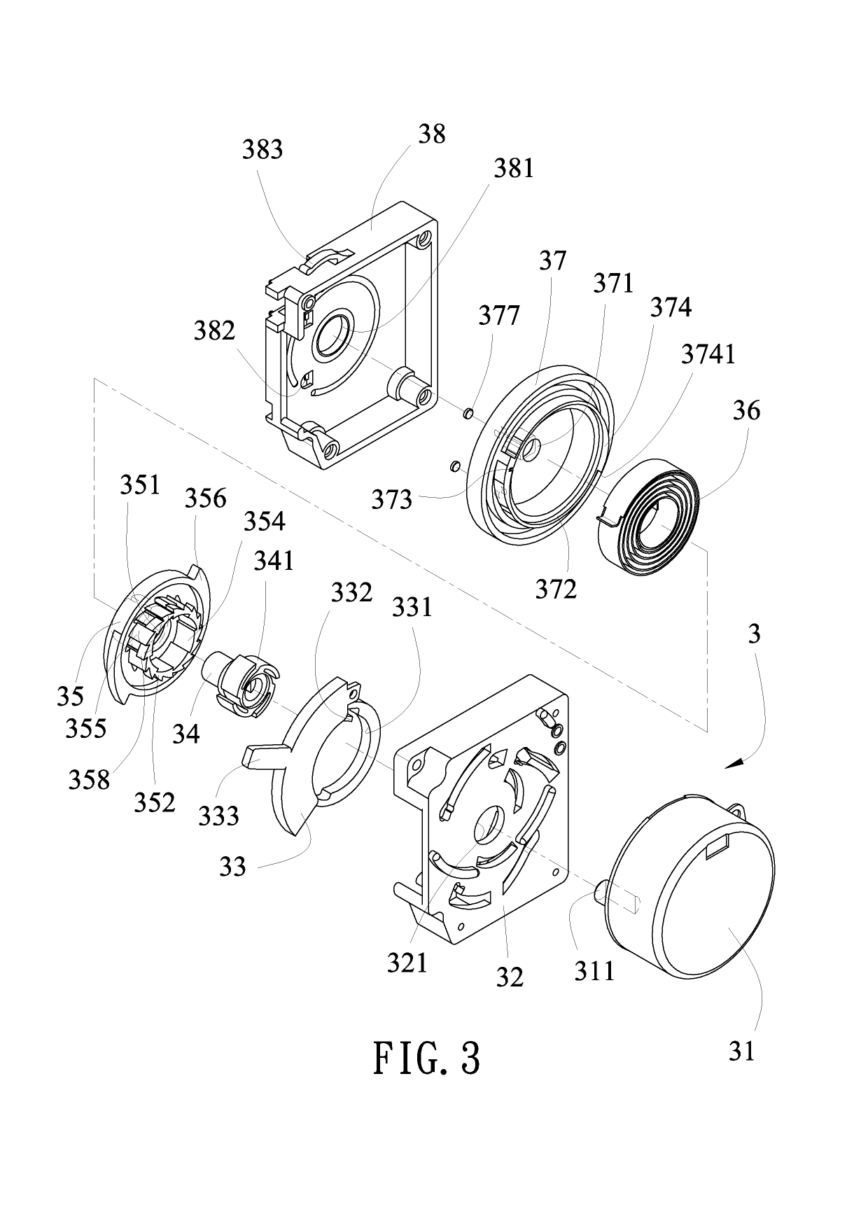

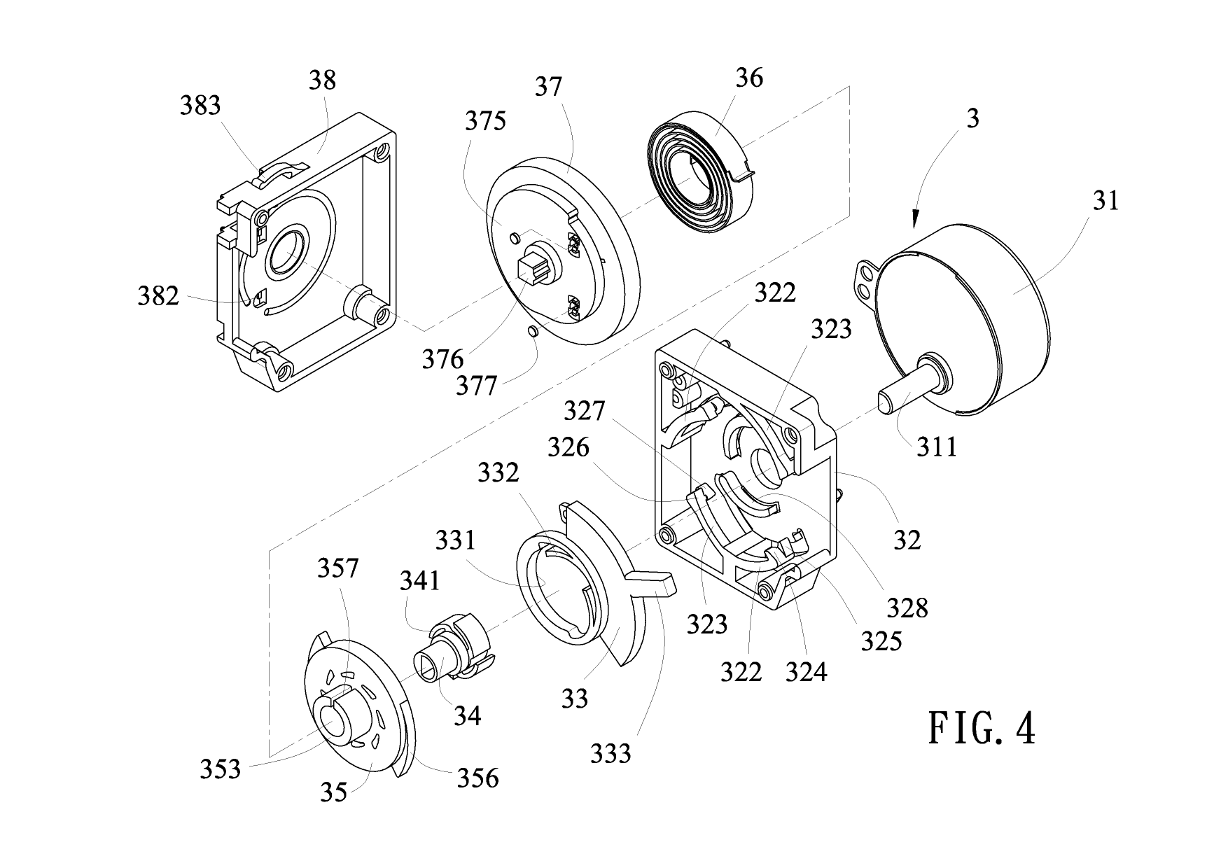

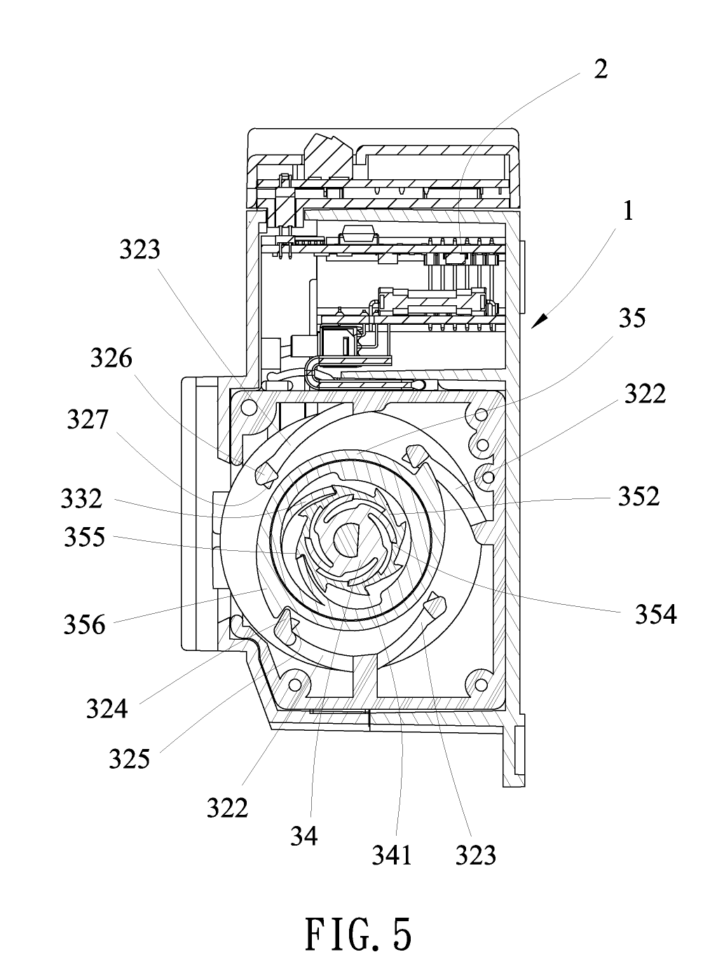

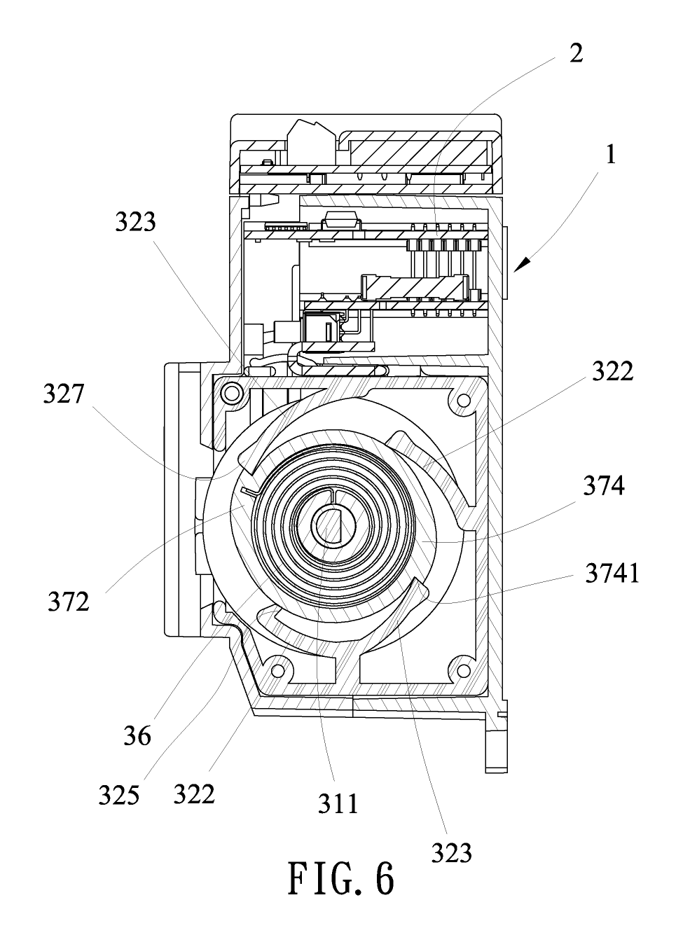

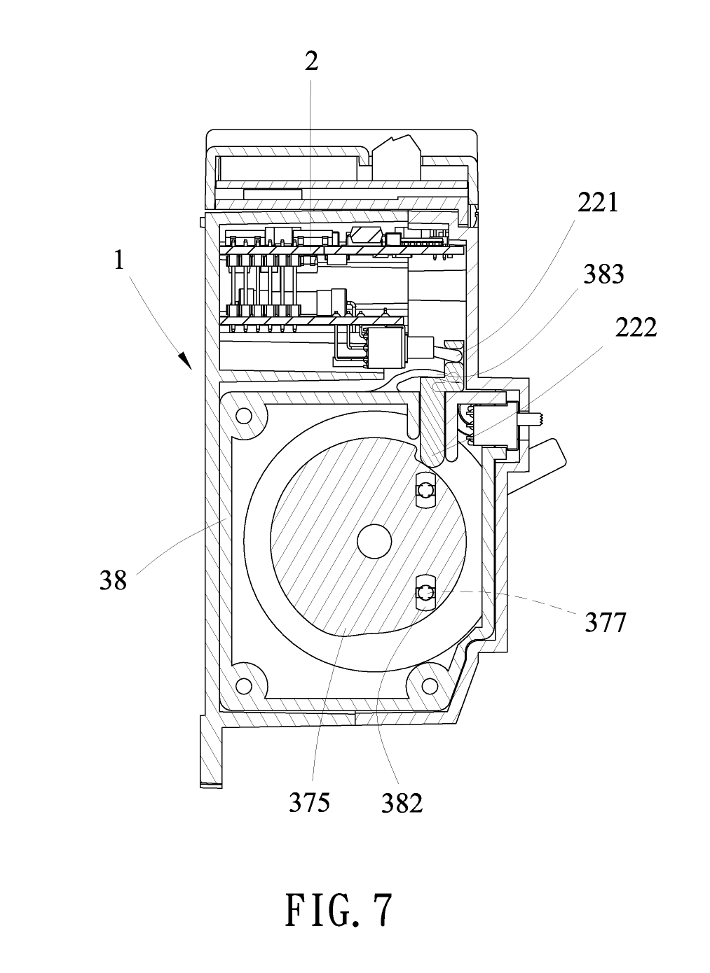

Also refer to FIGS. 3 and 4, the driving unit 3 is mounted in the first mounting space 12 of the switch body 1 and provided with a motor 31, a first cover 32, a lever member 33, a transmission shaft 34, a first rotary disc 35, an elastic member 36, a second rotary disc 37, and a second cover 38. The lever member 33, the transmission shaft 34, the first rotary disc 35, the elastic member 36, and the second rotary disc 37 are mounted in a space formed between the first cover 32 and the second cover 38 aligned and connected with each other. The elastic member 36 is a disc spring. A notch 39 is formed on one side of the first cover 32 and one side of the second cover 38 aligned and joined together. A position and a shape of notch 39 is corresponding to those of the long slot 15 on one of the cases 11 of the switch body 1. The motor 31 is not only connected to the control module 21 of the power management unit 2 for sending signal but also electrically connected to the power supply module 23 of the power management unit 2. A center of the first cover 32 is provided with a first through hole 321 through which a rotary shaft 311 of the motor 31 is inserted in to be connected to the transmission shaft 34 having a plurality of first ratchets 341 arranged therearound. Also refer to FIG. 5, the first rotary disc 35 consists of a first axial hole 351 at a center thereof, a first assembly ring 352, a second assembly ring 353, a plurality of second ratchets 354 formed on a wall surface of a hole of the first assembly ring 352 and able to engage with the first ratchets 341 of the transmission shaft 34, a plurality of third ratchets 355 formed on an outer surface of a cylindrical wall of the first assembly ring 352, two curved first flanges 356 disposed on a circumferential surface of the first rotary disc 35 and arranged opposite to each other, a first mounting slot 357 arranged at the second assembly ring 353 for mounting one end of the elastic member 36, and a plurality of fourth ratchets 358 disposed beside the third ratchets 355. Every two of the third ratchets 355 is provided with one of the fourth ratchets 358. The first rotary disc 35 includes a first end surface and a second end surface opposite to each other. The first assembly ring 352 and the second assembly ring 353 are respectively formed on the first end surface and the second end surface and the hole of the first assembly ring 352 and a hole of the second assembly ring 353 are concentric with the first axial hole 351. An outer diameter of the curved first flange 356 is gradually increased. Similarly, the second rotary disc 37 is provided with a second axial hole 371 at a center thereof, a first end surface, and a second end surface opposite to the first end surface. A third assembly ring 372 and a cam portion 375 are respectively formed on the first end surface and the second end surface of the second rotary disc 37. A hole of the third assembly ring 372 is concentric with the second axial hole 371. The elastic member 36 is mounted in the hole of the third assembly ring 372 which is provided with a second mounting slot 373 for mounting the other end of the elastic member 36. Refer to FIG. 6, two curved second flanges 374 are disposed on a circumferential surface of the third assembly ring 372 and opposite to each other. An outer diameter of the curved second flange 374 is gradually increased and a stopping portion 3741 is formed at a rear end of the curved second flange 374. A transmission portion 376 is arranged at a center of a surface of the cam portion 375 and concentric with the second axial hole 371. Two magnetic bodies 377 are disposed on the surface of the cam portion 375 and positioned on opposite sides of the transmission portion 376. A second through hole 381 is mounted to a center of the second cover 38 and the transmission portion 376 of the second rotary disc 37 is inserted into the second mounting space 13 of the switch body 1 through the second through hole 381 of the second cover 38. Also refer to FIG. 7, two sensors 382 are arranged at an inner surface of the second cover 38 and positioned on opposite sides of the second through hole 381 for sensing positions of the two magnetic bodies 377 on the second rotary disc 37 correspondingly. The two sensors 382 are connected to the control module 21 of the power management unit 2 for sending signals. An elastic strip 383 is disposed on a top end of the second cover 38 and linked to the linkage rod 222 of the power management unit 2. A bottom end of the linkage rod 222 is in contact with and abutting against a circumference of the cam portion 375 of the secondary rotary disc 37. The first cover 32 further includes two first leaf springs 322 opposite to each other and two second leaf springs 323 opposite to each other, both arranged at an inner surface of the first cover 32 and located around the first through hole 321. One end of the first leaf spring 322 is provided with a first guide portion 324 and a first stopping portion 325 arranged adjacent to each other. One end of the second leaf spring 323 is provided with a second guide portion 326 and a second stopping portion 327 disposed adjacent to each other. The first guide portion 324 of the first leaf spring 322 and the second guide portion 326 of the second leaf spring 323 are corresponding to the two first flanges 356 of the first rotary disc 35. The first stopping portion 325 of the first leaf spring 322 and the second stopping portion 327 of the second leaf spring 323 are corresponding to the two second flanges 374 of the second rotary disc 37. Two third leaf springs 328 are disposed on the inner surface of the first cover 32 and located at an area between the first through hole 321 and the first leaf spring 322 and an area between the first through hole 321 and the second leaf spring 323 correspondingly. The lever member 33 is provided with an assembly hole 331 and a plurality of fifth ratchets 332 is formed on a wall surface of the assembly hole 331 for being engaged with the third ratchets 355 formed on the outer surface of the cylindrical wall of the first assembly ring 352. The fourth ratchets 358 beside the third ratchets 355 are abutting against and limited by the two third leaf springs 328 on the inner surface of the first cover 32. A toggle lever 333 formed on one side of the lever member 33 is protruding from the long slot 15 of one of the cases 11 of the switch body 1 through the notch 39 located on the side of the first cover 32 and the side of the second cover 38.

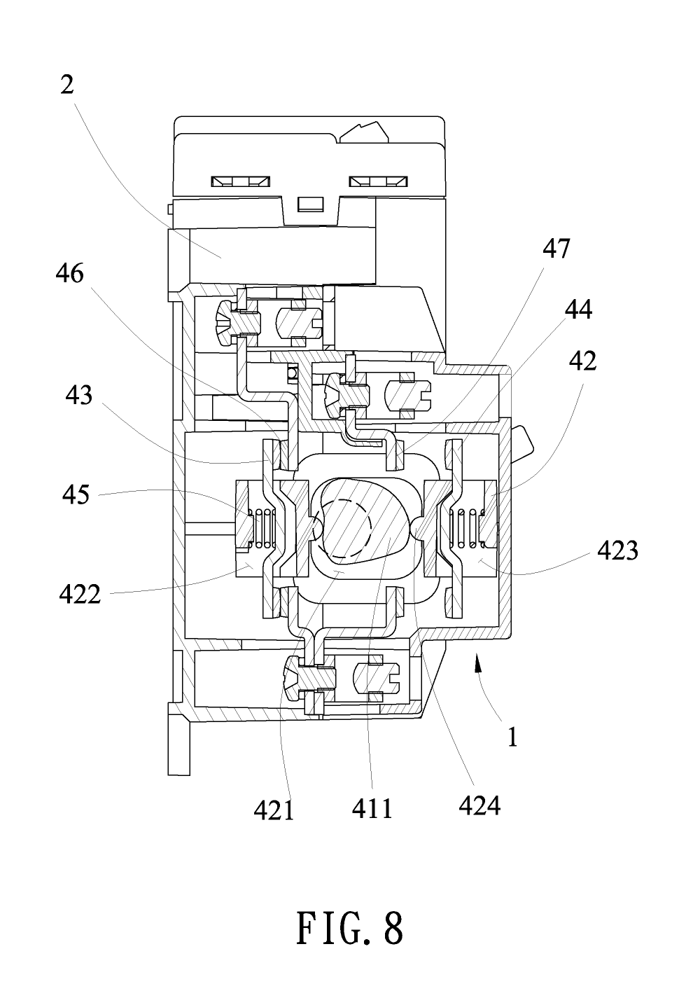

The power source switch unit 4 is disposed in the second mounting space 13 of the switch body 1 and composed of a crankshaft 41, a plurality of driven members 42 each of which having a first cavity 421, a second cavity 422, and a third cavity 423, a first conductor 43 and a second conductor 44 respectively mounted in the second cavity 422 and the third cavity 423 of the respective driven members 42, a plurality of elastic bodies 45, and a normal power source electrode 46 and a backup power source electrode 47 arranged in the respective rooms 131 of the second mounting space 13. One end of the crankshaft 41 is connected to the transmission portion 376 of the second rotary disc 37 and provided with a plurality of cams 411 spaced apart from one another in a lengthwise direction and located at the rooms 131 of the second mounting space 13 of the switch body 1 correspondingly. The second cavity 422 and the third cavity 423 are disposed on two opposite sides of the first cavity 421 correspondingly. Also refer to FIG. 8, each of the cams 411 of the crankshaft 41 is mounted in the first cavity 421 of each of the driven members 42 correspondingly. A bump 424 is formed on each of two opposite cavity walls of the first cavity 421 to be in contact with the cam 411 of the crankshaft 41. Both the second cavity 422 and the third cavity 423 are provided with one of the elastic bodies 45 for being in contact with and abutting against the first conductor 43 and the second conductor 44 correspondingly. The elastic body 45 is a compression spring. Two ends of the normal power source electrode 46 and two ends of the backup power source electrode 47 respectively are moveably contacted with or separated from two ends of the first conductor 43 and two ends of the second conductor 44.

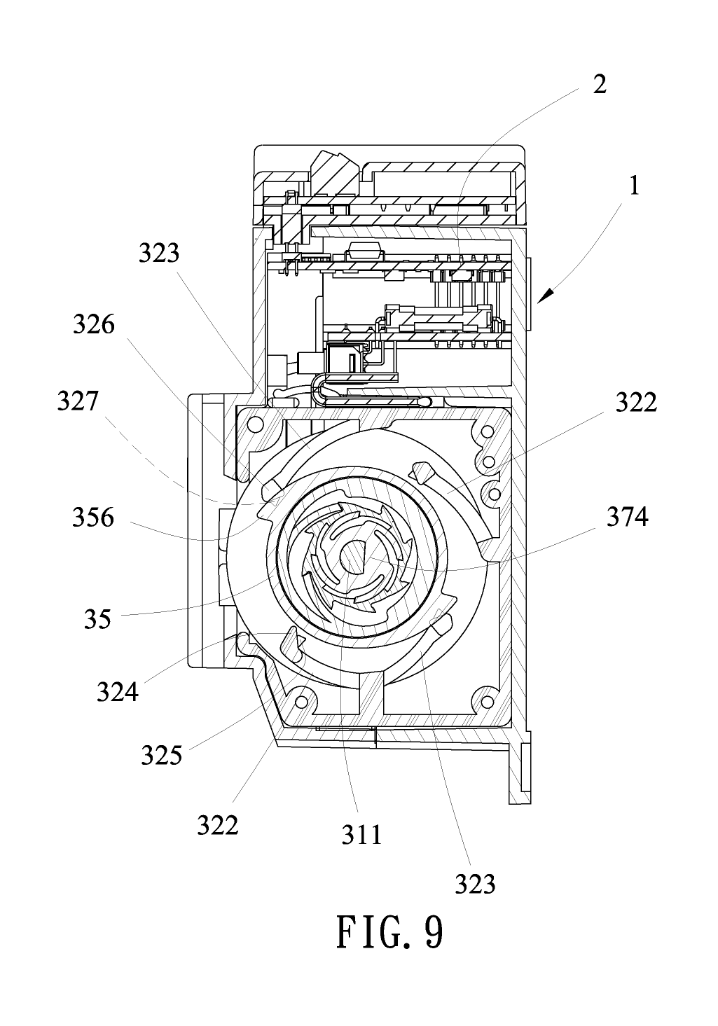

When a power supplied to load equipment 5 from the normal power source is interrupted or lost, the power management unit 2 detects the interruption or loss of the normal power source in a real time manner. Now the control module 21 of the power management unit 2 drives the motor 31 of the driving unit 3 using a backup power source to run. Thus the transmission shaft 34 assembled with the motor 31 is driven to rotate and further drive the first rotary disc 35 to rotate by the first ratchets 341 engaged with the second ratchets 354 of the first rotary disc 35. Then the first rotary disc 35 drives the elastic member 36 connected to wind for energy storage. Also refer to FIG. 9, when the first rotary disc 35 is rotated, the two curved first flanges 356 push the two first leaf springs 322 out gradually by the first guide portions 324 of the two first leaf springs 322 on the inner surface of the first cover 32 in contact with the curved first flanges 356. Thus the stopping portions 3741 of the two curved second flanges 374 of the second rotary disc 37 are gradually released from the first stopping portions 325 of the two first leaf springs 322, without being stopped. When the first stopping portions 325 of the two first leaf springs 322 and the two curved second flanges 374 of the second rotary disc 37 are completely separated from each other, the elastic member 36 releases its restoring elastic force to drive the second rotary disc 37 to rotate. When the second rotary disc 37 rotates 90 degrees, the stopping portions 3741 of the two curved second flanges 374 are stopped by the second stopping portions 327 of the two second leaf springs 323 and thus rotation of the second rotary disc 37 is temporarily stopped.

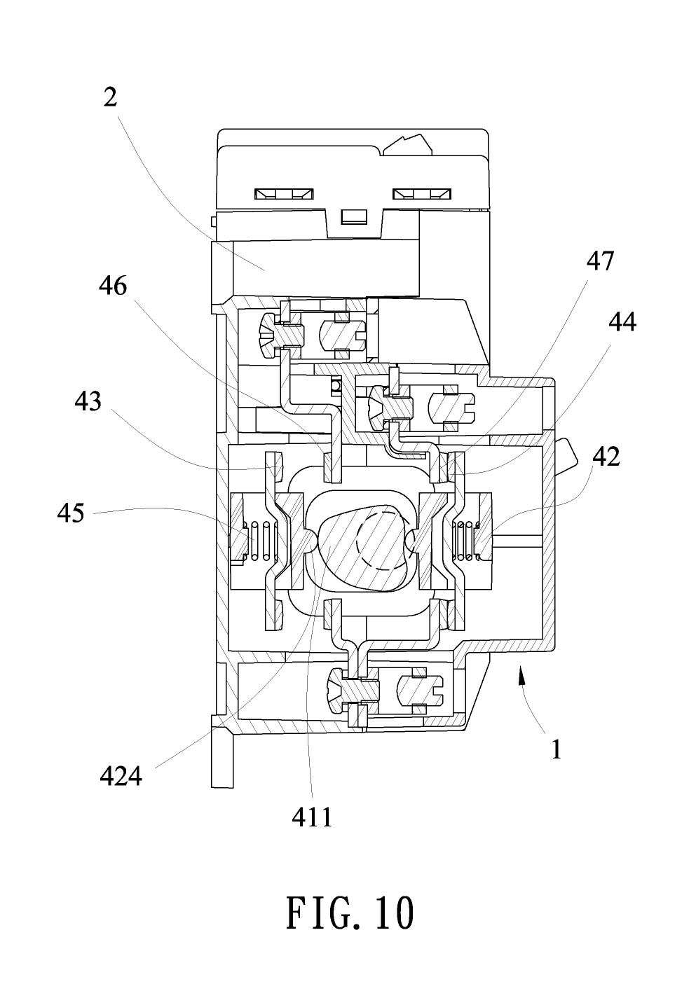

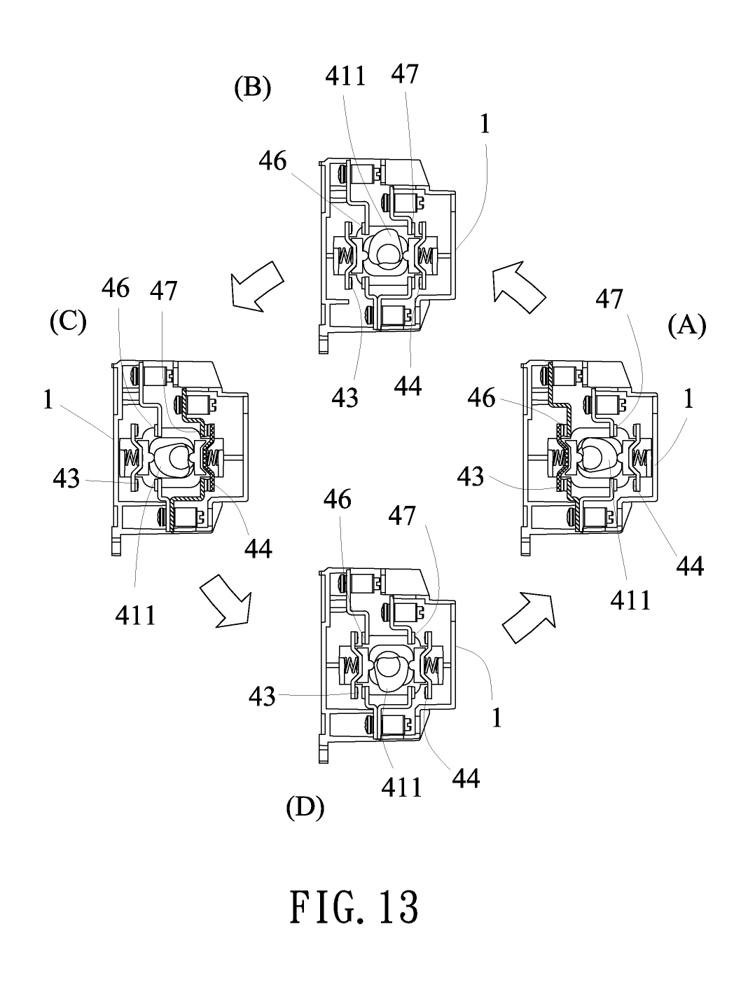

Refer to part A in FIG. 13, when the second rotary disc 37 rotates 90 degrees, the crankshaft 41 of the power source switch unit 4 connected with the transmission portion 376 of the second rotary disc 37 and the cam 411 on the crankshaft 41 are also rotated 90 degrees. Also refer to part B in FIG. 13, after the cam 411 on the crankshaft 41 being rotated 90 degrees, the cam 411 of the crankshaft 41 is abutting against the first conductor 43 and the second conductor 44 at the same time so that the first conductor 43 originally in contact with the normal power source electrode 46 is released from a state in contact with the normal power source electrode 46. At the moment, the first conductor 43 and the second conductor 44 are respectively not contacted with the normal power source electrode 46 and the backup power source electrode 47 simultaneously so that the load equipment 5 is in a complete power-off state. Along with rotation of the first rotary disc 35 driven by the motor 31 of the driving unit 3 continuously, the elastic member 36 mounted to the first rotary disc 35 is wound again for storage of the energy. When the first rotary disc 35 is rotated, the two curved first flanges 356 pushes the two second leaf springs 323 out gradually by the second guide portions 326 of the two second leaf springs 323 on the inner surface of the first cover 32 in contact with the curved first flanges 356. Thus the stopping portions 3741 of the two second flanges 374 of the second rotary disc 37 are gradually separated from the second stopping portions 327 of the two second leaf springs 323, without being stopped. When the two curved second flanges 374 of the second rotary disc 37 is completely separated from the second stopping portions 327 of the two second leaf springs 323, the elastic member 36 releases its restoring elastic force to drive the second rotary disc 37 to rotate 90 degrees again. Also refer to part C in FIG. 13, at the moment, the crankshaft 41 of the power source switch unit 4 connected to the second rotary disc 37 and the cam 411 on the crankshaft 41 are also rotated 90 degrees (total 180 degrees). Thus the cam 411 on the crankshaft 41 is no more abutting against the second conductor 44 and now the second conductor 44 is pushed against by the elastic body 45 in contact with itself and moved toward the backup power source electrode 47. Thus the two ends of the second conductor 44 are in contact with the two ends of the backup power source electrode 47, as shown in FIG. 10. Therefore, the backup power source and the load equipment 5 are electrically connected and the load equipment 5 can operate again by power from the backup power source.

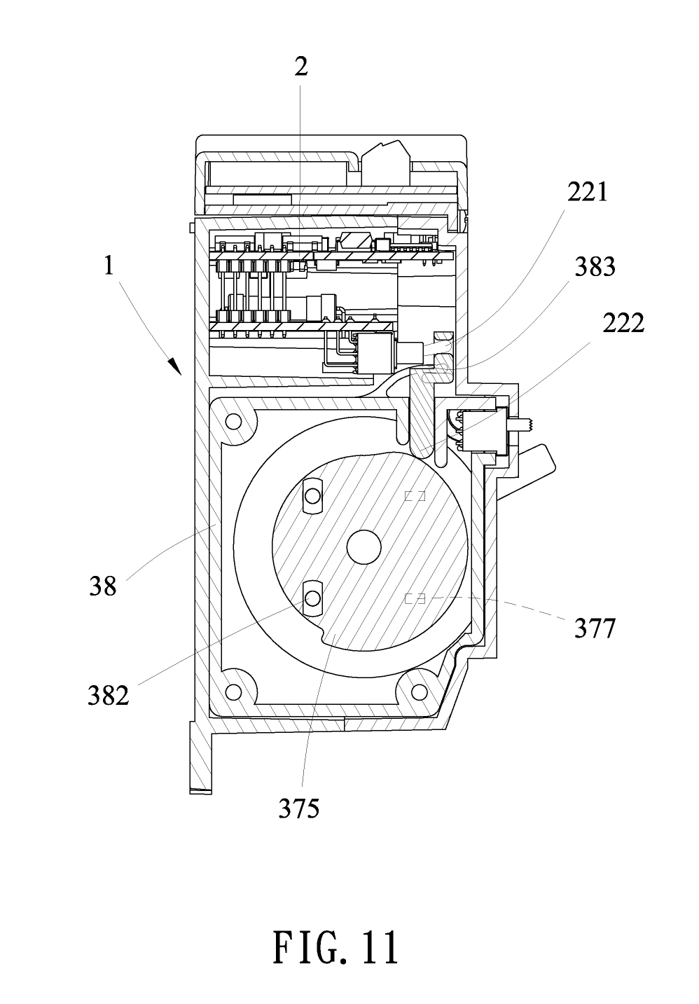

When the second rotary disc 37 rotates 180 degrees, also refer to FIG. 11, the linkage rod 222 of the power management unit 2 in contact with the circumference of the cam portion 375 of the secondary rotary disc 37 is pushed upward by the cam portion 375 of the secondary rotary disc 37 so that the transfer switch 221 assembled with the linkage rod 222 is toggled up and the power source supplied to the motor 31 of the driving unit 3 by the control module 21 of the power management unit 2 is switched to the normal power source in advance. Thereby once the power management unit 2 detects that the normal power source is restored, the control module 21 sends power from the normal power source to the motor 31 of the driving unit 3 for driving the first rotary disc 35 and the second rotary disc 37 to rotate 90 degrees through the transmission shaft 34. At the moment, also refer to part D in FIG. 13, the crankshaft 41 of power source switch unit 4 and the cam 411 on the crankshaft 41 are also rotated 90 degrees again (total 270 degrees). Thus the cam 411 of the crankshaft 41 is abutting against the first conductor 43 and the second conductor 44 at the same time so that the second conductor 44 is released from the state in contact with the backup power source electrode 47. At the moment, the first conductor 43 and the second conductor 44 are respectively not in contact with the normal power source electrode 46 and the backup power source electrode 47 so that the load equipment 5 is in the complete power-off state again.

Along with 90-degree rotation of the first rotary disc 35 and the second rotary disc 37 driven by the motor 31 of the driving unit 3 continuously, as shown in part A of FIG. 13, the crankshaft 41 of the power source switch unit 4 assembled with the second rotary disc 37 and the cam 411 of the crankshaft 41 are synchronously rotated 90 degrees again (total 360 degrees and back to the original position) so that the cam 411 of the crankshaft 41 is returned to its original position. Now the cam 411 of the crankshaft 41 is no more abutting against the first conductor 43. The first conductor 43 is pushed by the elastic body 45 in contact with the first conductor 43 and moved toward the normal power source electrode 46. Thus two ends of the first conductor 43 are in contact with the two ends of the normal power source electrode 46 (please also refer to FIG. 8). Therefore, the normal power source and the load equipment 5 are electrically connected and the load equipment 5 can operate again by power from the normal power source. After the normal power source and the load equipment 5 being electrically connected, the cam portion 375 of the secondary rotary disc 37 is released from the state of abutting against the linkage rod 222 of the power management unit 2. Now the linkage rod 222 is pulled downward and returned to its original position by elastic recovery of the elastic strip 383 on the top end of the second cover 38. Thus the transfer switch 221 assembled with the linkage rod 222 is toggled down and the power source supplied to the motor 31 of the driving unit 3 by the control module 21 of the power management unit 2 is switched to the preset backup power source. Thereby the motor 31 can work by using the backup power source when a loss of the normal power source occurs next time.

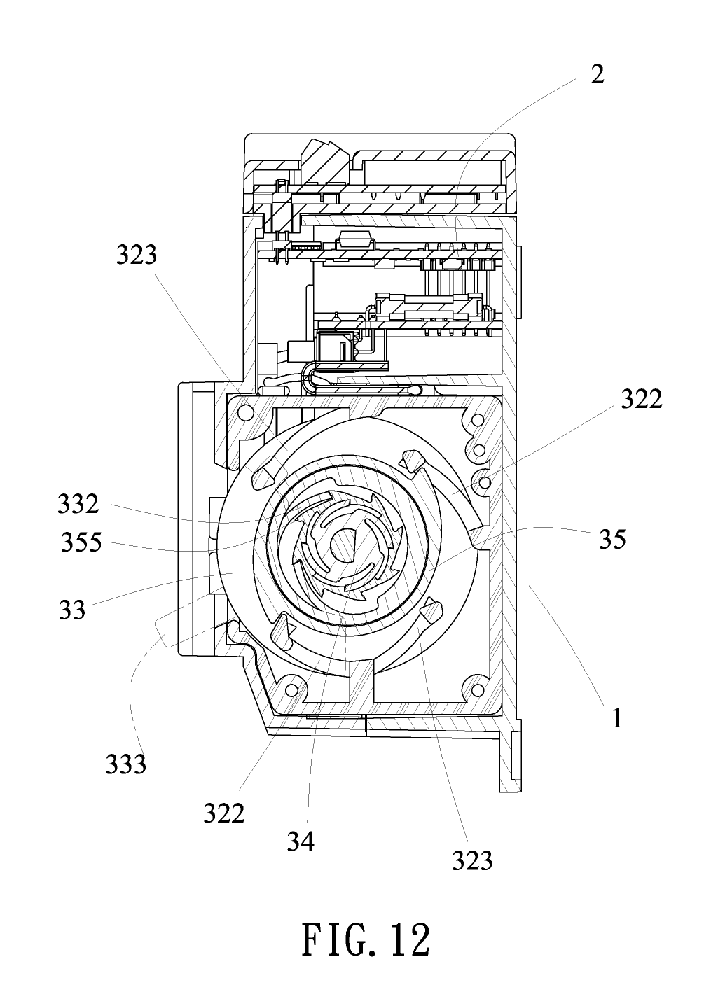

In addition, it is worth mentioning that when the second rotary disc 37 is rotated 90 degrees, the first conductor 43 of the power source switch unit 4 is released from the state in contact with the normal power source electrode 46 and the load equipment 5 is in a complete power-off state. Now only one of the two magnetic bodies 377 on the second end surface of the second rotary disc 37 and one of the two sensors 382 on the inner surface of the second cover 38 are corresponding to each other. Thus the sensor 382 sends signals related to the single magnetic body 377 sensed to the power management unit 2. Then the control module 21 of the power management unit 2 checks that the load equipment 5 is in a complete power-off state according to a built-in program. When the second rotary disc 37 is rotated 180 degrees, the second conductor 44 of the power source switch unit 4 is in contact with and abutting against the backup power source electrode 47 and the load equipment 5 is electrically connected to the backup power source. Now the two magnetic bodies 377 on the second end surface of the second rotary disc 37 and the two sensors 382 on the inner surface of the second cover 38 are staggered to each other. Thus the sensor 382 sends signals related to no magnetic body 377 sensed to the power management unit 2. Then the control module 21 of the power management unit 2 checks that the load equipment 5 has already been connected to the backup power source according to the built-in program. When the second rotary disc 37 is rotated 270 degrees, the second conductor 44 of the power source switch unit 4 is released from the state in contact with the backup power source electrode 47 and the load equipment 5 is in the complete power-off state again. Now only one of the two magnetic bodies 377 on the second end surface of the second rotary disc 37 and one of the two sensors 382 on the inner surface of the second cover 38 are corresponding to each other. Thus the sensor 382 sends signals related to the single magnetic body 377 sensed to the power management unit 2. Then the control module 21 of the power management unit 2 checks that the load equipment 5 is in a complete power-off state according to the program built in the control module 21. When the second rotary disc 37 is rotated 360 degrees, the first conductor 43 of the power source switch unit 4 is in contact with and abutting against the normal power source electrode 46 and the load equipment 5 is electrically connected to the normal power source. At the moment, the two magnetic bodies 377 on the second end surface of the second rotary disc 37 and the two sensors 382 on the inner surface of the second cover 38 are aligned to each other. Thus the two sensors 382 send signals related to the two magnetic bodies 377 sensed to the power management unit 2. Then the control module 21 of the power management unit 2 checks that the load equipment 5 has already been connected to the normal power source according to the built-in program. Once the normal power source is interrupted and the load equipment 5 hasn’t obtained power from the backup power source for a period of time, this means the automatic transfer function of the present switch may be damaged. Also refer to FIG. 12, now users can toggle the lever member 33 of the driving member 3 to move forward and backward by manual operation. Thus the lever member 33 drives the first rotary disc 35 to rotate due to the fifth ratchets 332 of the lever member 33 engaged with the third ratchets 355 of the first rotary disc 35. Then the first rotary disc 35 drives the elastic member 36, the second rotary disc 37, the crankshaft 41 of the power source switch unit 4, and the cam 411 of the crankshaft 41 to rotate in turn for switching connection between the load equipment 5 and the power sources including the normal power source and the backup power source. Improper rotation of the first rotary disc 35 during repeated operation of the lever member 33 can be prevented by the design of the fourth ratchets 358 of the first rotary disc 35 and the two third leaf springs 328 on the inner surface of the first cover 32 abutting against and limited by each other.

The above embodiments or figures are not intended to limit the implementations of the present invention. According to a period of time the different load equipment 5 takes to be disconnected to both the normal power source and the backup power source, parameters including rotation speed or pause time of the motor 31 of the driving unit 3 are set by the program built in the control module 21 of the power management unit 2 to keep the load equipment 5 at the complete power-off state temporarily during the switching between the normal power source and the backup power source. Thereby possible risks including power cross or accidental short circuit will not occur during the switching of the power source.

In summary, the present automatic transfer switch has the following advantages.

1. The present automatic transfer switch is provided with the neutral position during the switching between the normal power source and the backup power source to keep the load equipment at a complete power-off state temporarily during the switching in order to avoid possible risks including power cross or accidental short circuit during the switching. Thereby damages of the load equipment caused by the switching of the power sources can be prevented effectively.

2. The power management unit of the present automatic transfer switch is provided with the control module. According to the time different load equipment takes to be disconnected to both the normal power source and the backup power source, parameters including rotation speed or pause time of the motor of the driving unit are set by the control module. Thus different load equipment stays at a complete power-off state shortly during the switching of the power source and this increases service life of the respective loading equipment.

3. The present automatic transfer switch is provided with the lever member. Once automatic transfer function is out of order, users can still switch connection between the load equipment and the power sources including the normal power source and the backup power source by manual operations to increase ease of use.

4. By the motor or manual operation, the first rotary disc is driven to drive the elastic member to wind for energy storage. When the elastic member is moved to a certain position, it releases its restoring elastic force to drive the second rotary disc and the crankshaft of the power source switch unit linked to the secondary disc to rotate to a certain position. Thus the conductors of the power source switch unit are further driven to contact with or separate from the normal power source and the backup power source. By the energy-storage winding and immediate release design of the elastic members, the conductors of the power source switch unit can be not only in contact with or separated from the normal power source and the backup power source quickly but also tightly attached to each other to reduce resistance while in contact.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An automatic transfer switch comprising:
a switch body having a first mounting space and a second mounting space arranged adjacent to each other and both formed inside the switch body, the second mounting space separated into a plurality of rooms by a plurality of partitions;
a power management unit disposed on the switch body and provided with a control module, a transfer module having a transfer switch and a linkage rod assembled with the transfer switch, and a power supply module connected to the transfer switch of the transfer module for sending signals;
a driving unit mounted in the first mounting space of the switch body and including a motor, a first cover, a transmission shaft, a first rotary disc, an elastic member, a second rotary disc, and a second cover, the transmission shaft, the first rotary disc, the elastic member, and the second rotary disc are mounted in a space formed between the first cover and the second cover aligned and joined together, the motor not only connected to the control module of the power management unit for sending signals but also electrically connected to the power supply module of the power management unit, the first cover provided with a first through hole through which a rotary shaft of the motor is inserted to be connected to the transmission shaft, a plurality of first ratchets arranged around the transmission shaft, the first rotary disc provided with a first axial hole at a center thereof, a first end surface, a second end surface opposite to the first end surface, a first assembly ring and the second assembly ring respectively formed on the first end surface and the second end surface, a plurality of second ratchets formed on a wall surface of a hole of the first assembly ring and able to engage with the first ratchets around the transmission shaft, and two curved first flanges disposed on a circumferential surface of the first rotary disc and arranged opposite to each other, one end of the elastic member mounted to the second assembly ring of the first rotary disc, the second rotary disc provided with a second axial hole at a center thereof, a first end surface, a second end surface opposite to the first end surface, a third assembly ring and a cam portion respectively formed on the first end surface and the second end surface of the second rotary disc, two curved second flanges, and a transmission portion, the elastic member mounted in a hole of the third assembly ring and the other end of the elastic member assembled with the third assembly ring, the two curved second flanges disposed on a circumferential surface of the third assembly ring and opposite to each other and each of the curved second flanges provided with a stopping portion formed at a rear end thereof, the transmission portion arranged at a center of a surface of the cam portion and the second cover provided with a second through hole, the transmission portion of the second rotary disc inserted into the second mounting space of the switch body through the second through hole of the second cover, the first cover further including two opposite first leaf springs and two opposite second leaf spring arranged at an inner surface of the first cover and located around the first through hole, one end of the first leaf spring provided with a first guide portion and a first stopping portion arranged adjacent to each other, one end of the second leaf spring provided with a second guide portion and a second stopping portion disposed adjacent to each other, the first guide portion of the first leaf spring and the second guide portion of the second leaf spring corresponding to the two first flanges of the first rotary disc, the first stopping portion of the first leaf spring and the second stopping portion of the second leaf spring corresponding to the two second flanges of the second rotary disc, an elastic strip disposed on the second cover and linked to the linkage rod of the transfer module, a bottom end of the linkage rod in contact with and abutting against a circumference of the cam portion of the secondary rotary disc, and
a power source switch unit mounted in the second mounting space of the switch body and composed of a crankshaft, a plurality of driven members, a plurality of first conductors, a plurality of second conductors, a plurality of elastic bodies, a plurality of normal power source electrodes, and a plurality of backup power source electrodes, one end of the crankshaft mounted to the transmission portion of the second rotary disc and provided with a plurality of cams spaced apart from one another in a lengthwise direction and located at the rooms of the second mounting space of the switch body correspondingly, each of the driven members provided with a first cavity and a second cavity and a third cavity disposed on two opposite sides of the first cavity, each of the cams of the crankshaft mounted in the first cavity of each of the driven member correspondingly, a bump formed on each of two opposite walls of the first cavity to be abutting against and contacted with the cam of the crankshaft, the first conductor and the second conductor respectively mounted in the second cavity and the third cavity of the respective driven members, both the second cavity and the third cavity provided with one of the elastic bodies for being in contact with and abutting against the first conductor and the second conductor correspondingly, each of the normal power source electrodes and each of the backup power source electrodes mounted in each of the rooms of the second mounting space correspondingly, the normal power source electrode moveably contacted with or separated from the first conductor, the backup power source electrode moveably contacted with or separated from the second conductor.

2. The automatic transfer switch as claimed in claim 1, wherein two magnetic bodies are disposed on a surface of the cam portion of the second rotary disc of the driving unit and positioned on opposite sides of the transmission portion; two sensors are arranged at an inner surface of the second cover, positioned on opposite sides of the second through hole, and corresponding to the two magnetic bodies on the second rotary disc; and the two sensors are connected to the control module of the power management unit for sending signals.

3. The automatic transfer switch as claimed in claim 1, wherein a first mounting slot is arranged at the second assembly ring of the first rotary disc of the driving unit for mounting the one end of the elastic member; and a second mounting slot is formed on the third assembly ring of the second rotary disc for mounting the other end of the elastic member.

4. The automatic transfer switch as claimed in claim 1, wherein a long slot is mounted to one side of the switch body and a notch is formed on one side of the first cover and one side of the second cover joined together; a position and a shape of the notch is corresponding to a position and a shape of the long slot of the switch body; the automatic transfer switch further includes a lever member provided with an assembly hole and a plurality of fifth ratchets is formed on a wall surface of the assembly hole; a plurality of third ratchets is disposed on an outer surface of a cylindrical wall of the first assembly ring of the first rotary disc for being engaged with the fifth ratchets on the assembly hole of the lever member; and a toggle lever is formed on one side of the lever member and protruding from the long slot of the switch body through the notch on the one side of the first cover and the one side of the second cover.

5. The automatic transfer switch as claimed in claim 4, wherein two third leaf springs are disposed on the inner surface of the first cover and located at an area between the first through hole and the first leaf spring and an area between the first through hole and the second leaf spring correspondingly; and a plurality of a fourth ratchets is disposed beside the third ratchets on the first assembly ring of the first rotary disc and abutting against and limited by the two third leaf springs on the inner surface of the first cover.

6. The automatic transfer switch as claimed in claim 1, wherein the control module of the power management unit is a programmable logic controller (PLC).

7. The automatic transfer switch as claimed in claim 1, wherein the switch body is formed by two cases aligned and joined together.
